(19) United States
(12) Patent Application Publication
(10) Pub. No.: US 2017/0154051 A1
(43) Pub. Date: Jun. 1, 2017

(54) Hashmaps

(71) Applicant: Microsoft Technology Licensing, LLC, Redmond, WA (US)

(72) Inventors: Chelsea Nicole Mitchell, Redmond, WA (US); Romualdo Impas, Redmond, WA (US); Mahesh Prakriya, Redmond, WA (US); Dvir Horovitz, Redmond, WA (US); Samantha Neufeld, Redmond, WA (US); Carmen E. Au, Redmond, WA (US); Jyotkumar Patel, Redmond, WA (US)

(21) Appl. No.: 14/956,216

(22) Filed: Dec. 1, 2015

(51) Int. Cl. G06F 17/30; G06F 3/0482; G06F 3/0484

(52) U.S. Cl. CPC G06F 17/30097; G06F 17/30241; G06F 3/04842; G06F 3/0482

(57) ABSTRACT

Systems and methods for generating hashmaps are presented. According to the disclosed subject matter, computer users can identify a geo-location (a real-world geographic location) irrespective and independent of any known entity at the geo-location and associate content with regard to the identified location. The combination of the user-specified location and the corresponding, associated content is a “hashmap.” Additional information may be associated and included with a hashmap, including access restrictions to the hashmap by others, a user identifier of the creator of the hashmap, and a date and time. Users can search for hashmaps related to a particular area by submitting hashmap requests to a hashmap service.

### BACKGROUND

Some social networking sites allow users to create content and publish that content to other users, such as friends, family, fans, and the like. Frequently, the content that is published includes certain tokens that identify corresponding, subsequent subject matter or reference an entity. One such token is the pound sign or hash mark, ‘#,’ which is often referred to as a hashtag. Through the use of hashtags and other tokens, such as ‘@’ which may identify reference information, one user is often able to search for published content that includes or makes reference to the subject matter identified by the token, and particularly by a hashtag. For example, posted content such as “#Microsoft announces #SurfaceBook” makes reference to a release of a laptop computer and includes the hashtags “Microsoft” and “SurfaceBook.” This post/comment could be distributed to many others via a social network, and these others/social network users may subsequently search for this particular instance of content based on the hashtags, “Microsoft” and “SurfaceBook.”

Some social networking sites allow users to post comments with regard to particular entities, and these posts may include hashtag and/or other searchable references. For example, a social networking site directed to providing restaurant reviews, will allow its users to post comments/content with regard to particular restaurants. Similarly, vendors will allow its subscribers to post comments and/or content with regard to particular items that were purchases. However, these social networking sites restrict the users to comments on known entities, i.e., a particular set of entities that are managed/kept by the particular social networking service. These entities may include restaurants, goods and/or services, organizations, cruise lines, and the like. Moreover, some of these known entities, such as restaurants, zoos, parks, golf courses, and the like, may be associated with a particular location. For example, the location of a golf course may be well known, or the location of a restaurant may also be known. As such, when a social network user posts a comment with regard to a particular entity, the comment is indirectly associated with the location and a map of the location may show social comments with regard to a particular location. However, with regard to the users' posts, the specific geographic location for a given entity is incidental to the entity being reviewed or otherwise commented upon.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods, and computer-readable media, for generating hashmaps are presented. According to the disclosed subject matter, computer users can identify a geo-location (a real-world geographic location) irrespective and independent of any known entity at the geo-location and associate content with regard to the identified location. The combination of the user-specified location and the corresponding, associated content is a “hashmap.” Additional information may be associated and included with a hashmap, including access restrictions to the hashmap by others, a user identifier of the creator of the hashmap, and a date and time. Users can search for hashmaps related to a particular area by submitting hashmap requests to a hashmap service.

According to additional aspects of the disclosed subject matter, a computer-implemented method for generating a hashmap on a user computing device is presented. In execution, a geo-location for generating a hashmap is obtained. Moreover, the geo-location is obtained irrespective of any known entity at the geo-location. Content (one or more items of content) for the hashmap are obtained and a hashmap record is generated according to and from the geo-location and the content. The hashmap record is then submitted to a hashmap service that manages hashmaps for a plurality of users over a computer network.

According to further aspects of the disclosed subject matter, a computer-readable medium bearing computer-executable instructions is presented. The instructions, when executed on a user computing device comprising at least a processor and a memory, carry out a method for generating a hashmap corresponding to a geo-location. The method includes obtaining a geo-location for generating the hashmap, where the geo-location is obtained irrespective of any known entity at the geo-location. Additionally, one or more items of content are obtained for inclusion as part of the hashmap. A hashmap record is generated according to the geo-location and the one or more items of content and the hashmap record is then submitted to a hashmap service that manages hashmaps for a plurality of users over a computer network.

According to still further aspects of the disclosed subject matter, a computer system for responding to a hashmap request from a computer user via a user computing device over a computer network is presented. The computer system includes at least a processor and a memory, where the processor executes instructions stored in the memory in implementing a hashmap service on the computer system. The computer system further includes a hashmap service component and a hashmap data store. Regarding the hashmap data store, this data store stores a plurality of hashmaps for a plurality of computer users for access by computers through an executing hashmap service. The hashmap service component, then, in execution, implements the hashmap service. In operation, the hashmap service receives a hashmap request and obtains hashmaps from the hashmap data store that satisfy the request via a request module. The obtained hashmaps are filtered via a filter module according to one or more filters applicable to the requesting computer user. A return record is generated via a generation module, where the return record includes one or more obtained, filtered hashmaps (i.e., the remaining, obtained hashmaps after the filtering by the filtering module.) The return record is then returned to the requesting computer user in response to the received hashmap request.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is block diagram illustrating an exemplary network environment suitable for implementing aspects of the disclosed subject matter;

FIG. 2 is a flow diagram illustrating an exemplary routine for generating a hashmap with regard to a particular geo-location;

FIG. 3 is a flow diagram illustrating an exemplary routine for obtaining a geo-location for a computing device;

FIG. 4 is a flow diagram illustrating an exemplary routine for responding to a hashmap request from a computer user;

FIG. 5 illustrates and exemplary computer-readable media that may be manufactured in accordance to aspects of the disclosed subject matter;

FIG. 6 is a block diagram illustrating an exemplary user computing device suitable for creating a hashmap; and

FIG. 7 is a block diagram illustration an exemplary hosting computer suitable for implementing a hosting service for receiving hashmap records and responding to hashmap requests.

### DETAILED DESCRIPTION

While there may be sites and services that allow their users to posts content regarding entities that are at known locations, these services do not enable their users to identify a geographic location and then associate content via a post with that geographic location. According to aspects of the disclosed subject matter, users of the disclosed service can identify a location irrespective and independent of any known entity at the geo-location and associate content with regard to the identified location. The combination of a user-specified location and corresponding content is referred to hereafter as a “hashmap.”

As the name suggests, in addition to a user-specified location, the hashmap may include tokens (with corresponding, subsequent topics or subject matter) that can be used for quick identification of the combination of geographic location and user post. For example, while a general location, and even the entire area, of a golf course may be known and displayable on a map, a user of a hashmap service (i.e., an online service in which users are able to submit hashmaps over a network) may be able to identify a particular location in which the user made a memorable shot. For example, a user may identify a particular geographic location within a golf course and associate content with that location (e.g., “My first #hole-in-One!”) and submit the location and content to the hashmap service as a hashmap. Correspondingly, in regard to displaying hashmap information, a mapping application or service may be integrated (to some degree) with the hashmap service such that hashmaps may be displayed with regard to their corresponding geographic location.

In addition to associating user-generated content with a geographic location, the hashmap is also associated with the submitting user. In this manner, the hashmap service may provide its users with access control over their submitted hashmaps. In other words, a first user may identify one or more others users, group or groups of users (including explicitly defined groups as well as implicitly identified groups), or all users as having access to any given hashmap submitted by the first user. Further still, a first user may indicate a date and/or time in association with a hashmap. In this manner, filtering on hashmaps may occur based any one or more of a subject matter (independent of any tokens identifying specific subjects and/or entities), according to specifically identified entities (i.e., according to hashtags and/or other tokens in the content), by originator (i.e., the person that submitted the hashmap to the hashmap service), and by content type (i.e., according to the type of content—e.g., text, audio, image, video, etc.), as will be described in greater detail below.

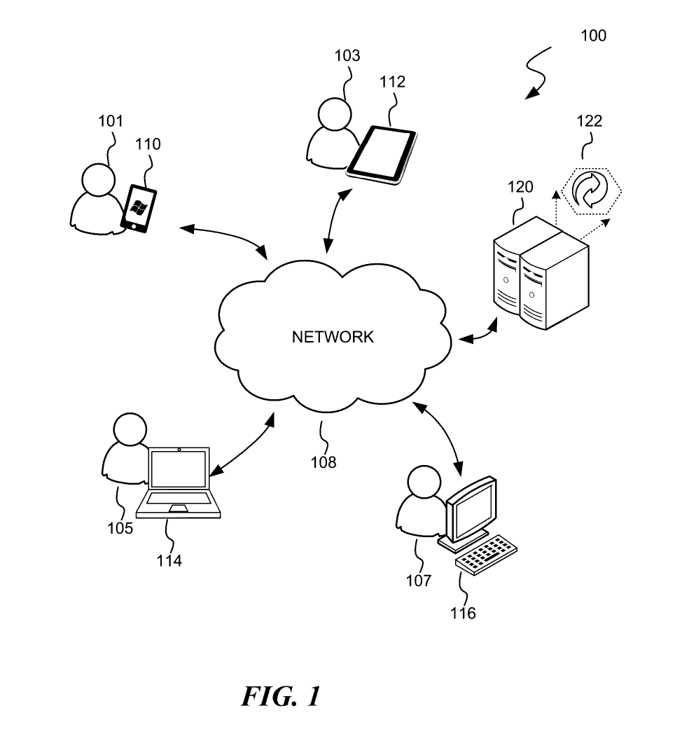

Turning now to the figures, FIG. 1 is a block diagram illustrating an exemplary network environment 100 suitable for implementing aspects of the disclosed subject matter. In particular and by way of illustration without limitation, the network environment 100 includes user computers 110-116, each corresponding to a computer user (e.g., computer user 101-107). As suggested in the exemplary network environment 100, user computers suitable for implementing aspects of the disclosed subject matter include, by way of illustration and not limitation, mobile computing devices such as mobile phone 110, tablet computing devices such as tablet computer 112, laptop computers such as laptop computer 114, and desktop computers, such as desktop computer 116. Generally speaking, suitable user computing devices include those devices that can identify a geo-location of a hashmap, either through geo-location services available to the computing device or as a function of user selection or identification (such as location identification via a map), as well as associate content with the geo-location.

According to aspects of the disclosed subject matter, the user computing devices generate one or more hashmaps, typically at the explicit direction of the corresponding computer user, and submit the generated hashmap to a hashmap service 122 operating on a hosting computer 120. In this regard, the user computers 110-116 and the hosting computer 120 are interconnected via a network 108. By way of illustration and not limitation, the network 108 corresponds to communication technology by which the various computers, including user computers 110-116 and hosting computer 120, can inter-communicate including sending and receiving data. This communication technology may comprise the Internet (a global system of interconnected computer networks that use the Internet protocol suite to the devices), a wide area network or WAN, a local-area network or LAN, intranets, various combinations of the foregoing, and the like. Those skilled in the art will appreciate that the various computers 110-116 and 120 may inter-communicate over the network 108 by way of wired connections, wireless connections, optical connections, and the like. While a single network, network 108, is illustrated, inter-communication between computing devices may occur over more than one network. For example, while user computers 112-116 may communicate over network 108 with hashmap service 122, in one illustrative, alternative embodiment (not shown), user computer 110 may communicate with hashmap service 122 over an alternative, telephone network.

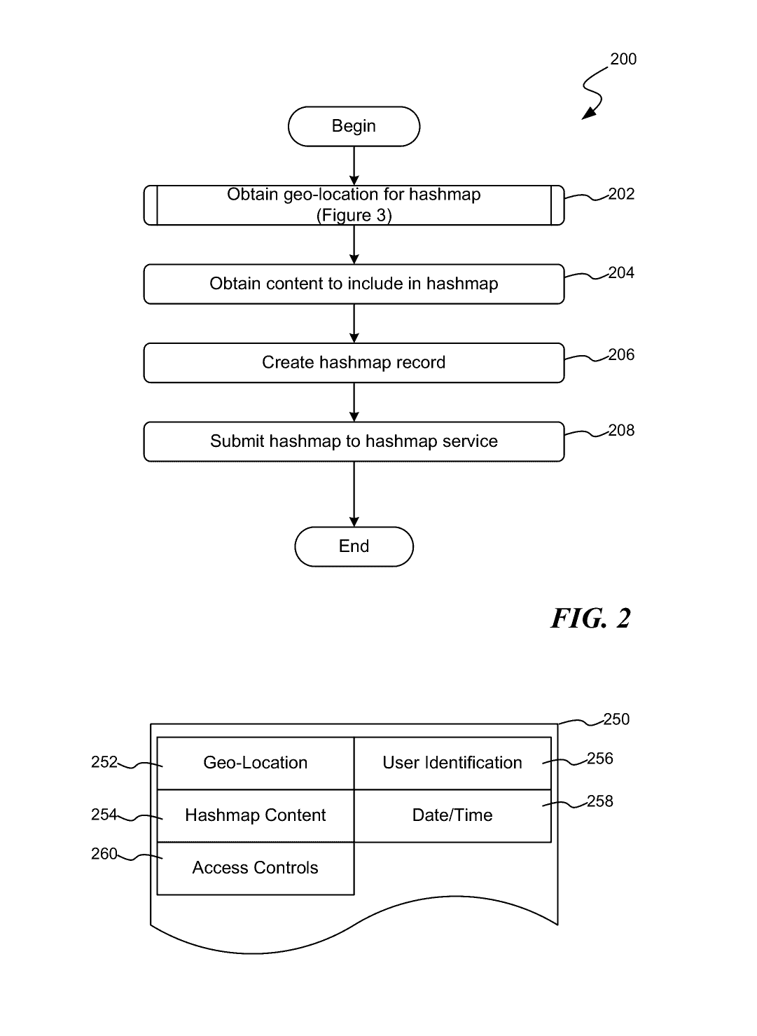

In regard to generating hashmaps by a computer user via a user computer, reference is now made to FIG. 2. FIG. 2 is a flow diagram illustrating an exemplary routine 200 for generating a hashmap with regard to a particular geo-location. Beginning with block 202, a geo-location for a hashmap is obtained. As used in this document, a geo-location is a real-world geographic location, i.e., global coordinates. Typically, though not exclusively, a geo-location is expressed in terms of a latitude/longitude pair. For example, the geo-location of a person located at the Space Needle in Seattle would be {47.6204° N, 122.3491° W}.

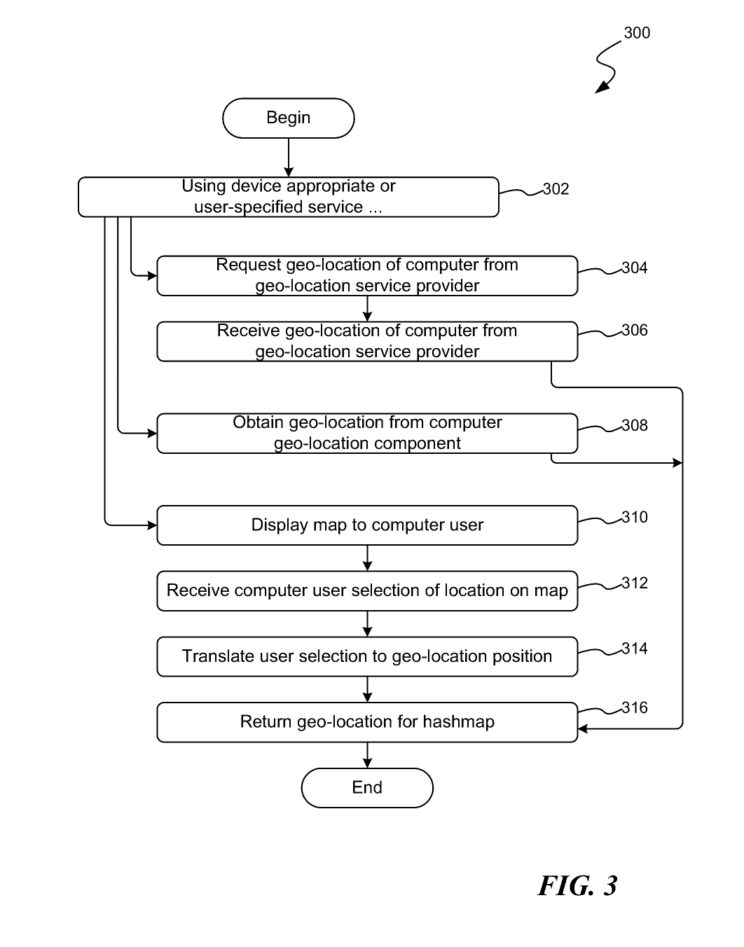

As will be appreciated, for any given computer or computing device the mechanism by which the geo-location is obtained may be different from another device. Indeed, in regard to obtaining a geo-location, FIG. 3 is a flow diagram illustrating an exemplary routine 300 for obtaining a geo-location. Beginning at block 302 and by using a device-available and/or user-specified geo-location service, one of a plurality of mechanisms for obtaining a geo-location is implemented. Of course, while routine 300 identifies 3 common mechanisms for obtaining a geo-location, these should be viewed as illustrative and not limiting upon the disclosed subject matter. Those skilled in the art will appreciate that they may be other mechanisms for obtaining a geo-location according to specific device and software abilities and needs.

With regard to routine 300, a first mechanism for obtaining a geo-location may be to obtain the geo-location from a third party service. For example, many mobile phone services have particular abilities to locate (identify a geo-location) a mobile phone that is using its services. These abilities include, by way of illustration and not limitation, triangulation of signals, signal strengths, and the like. Accordingly, in block 304, the user computer, on behalf of the user and/or a request to generate a hashmap, requests a geo-location of the computer from a third-party geo-location service provider. Typically, this comprises submitting a request to the third-party geo-location service provider over a network, such as network 108. In response and at block 306, the geo-location of the computer is received from the third-party geo-location service provider. Thereafter, the routine 300 proceeds to block 316 where the geo-location is returned for use in the hashmap.

In the alternative to obtaining a geo-location from a third party service, many computing devices, especially mobile computing devices, include geo-location sensing abilities. For example, many mobile phones, personal digital assistants, tablet computers, so-called phablet computers (hybrid phone/tablet devices), even laptops now includes a geo-location sensing module, typically a Global Positioning System (GPS), which can be accessed to determine the geo-location of the computer/device. Thus, at block 308, a geo-location is obtained from a geo-location module/component disposed in the user computer (or user device). Thereafter, as above, the routine 300 proceeds to block 316 where the geo-location is returned for use in the hashmap.

In yet another alternative to obtaining a geo-location for use in a hashmap, a user may specify a location, e.g., via identifying a location on a map that is displayed to the user. For example, a user may wish to generate a hashmap in regard to a particular event/location that previously occurred. In one example, a user may wish to identify a location in which a particularly rare bird was sighted and, by way of a map, identifies a location on the map that of that sighting. Those skilled in the art will appreciate that, given a particular map which has one or more known geo-location coordinates and orientation, the geo-location of a point within that map can be readily determined. Thus, with reference to routine 300, at block 310 a map is displayed to the computer user. At block 312, the computer user's identification/selection of a particular location on the map is received. At block 314, the user's selection is translated (according to known information regarding the geo-location of the map, its scale and orientation) into a geo-location. At block 316, the geo-location is returned for use in the hashmap. Thereafter, the routine 300 terminates.

Returning again to routine 200 of FIG. 2, after obtaining the geo-location to be used in the hashmap, the routine 200 obtains (or creates) content from the user to be used in the hashmap. According to aspects of the disclosed subject matter, the content that may be used in a hashmap includes, by way of illustration and not limitation, any one or more of textual content (which may or may not include one or more tokens such as hashtag tokens), pictures/images, video content, audio content, structured data and/or data files, hyperlinks, and the like. By way of illustration and example, in regard to a bird sighting whose location was pin-pointed on a map after the occasion, a user may identify a digital image of the bird as well as enter textual comment “#BaldEagle nesting by #Elwha river” for use in a hashmap.

At block 206, a hashmap record is formed. While no particular structure or arrangement of data in the hashmap record is required, according to aspects of the disclosed subject matter, a hash map record comprises at least a geo-location and corresponding content. Additionally, the hashmap record will also identify the computer user that is creating the hashmap record. The identity of the user may subsequently be used in order to enforce access restrictions and/or permissions of others to the hashmap. Indeed, according to various embodiments of the disclosed subject matter, each user of the hashmap service 122 may be provided with tools by which he/she can control access (both permissive and restrictive) by others to all of his/her hashmaps and/or in regard to individual hashmaps. For example and in reference to the bird sighting above, the user may wish to share the to-be-submitted hashmap about the bird sighting with friends that belong to a particular bird-watching group. On the other hand, a hashmap that is viewed as personal to the user may be identified as accessible to the user only, or alternatively to the user and a select/identified group of trusted friends. Indeed, generally applicable access rules may be established as well as individualized rules with regard to all or some of the hashmaps of a particular user. In addition to the geo-location, associated content, the identity of the user (as well as any access controls that the user may wish to place with regard to the to-be submitted hashmap), a date and time may also be optionally included (e.g., a user may wish to identify the date of the hashmap as the date that the bird sighting took place). Indeed, FIG. 2 further illustrates an exemplary hashmap record 250 that includes the geo-location 252, hashmap content 254, a user identification 256, optional date/time information 258, and optional access controls 260 corresponding to this hashmap record.

At block 208, the hashmap record is submitted to the hashmap service 122 as a hashmap from the computer user for inclusion in its hashmap data store. Thereafter, routine 200 terminates.

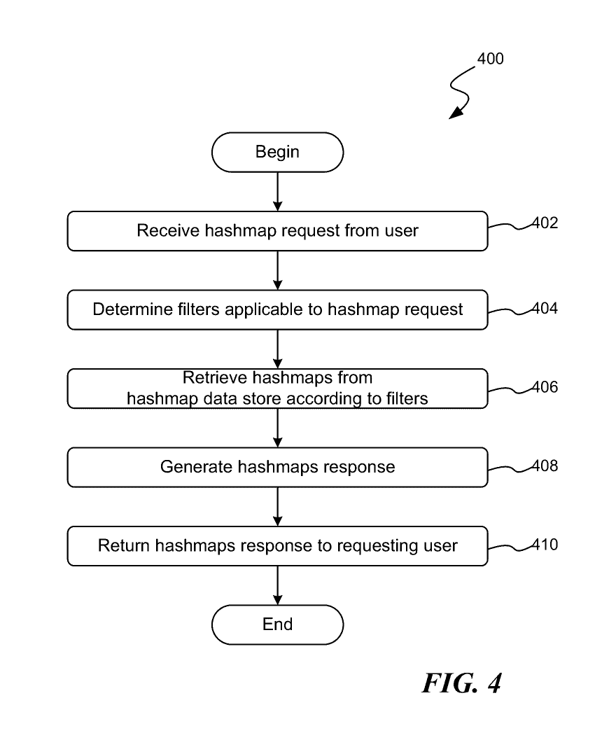

In addition to being able to submit hashmap records to the hashmap service 122, a user may also request hashmap data from the hashmap service 122. For example, a user may wish to identify locations (as indicated by hashmaps) in regard to a particular topic or in regard to a particular user. Illustratively, a second user may wish to located sites of bird sightings near the Elwha River. A request to the hashmap service 122 such as “bird sightings on Elwha River” may prompt the hashmap service to identify those hashmaps that meet all of some of the criteria in the hashmap request, generate a hashmap response, and return the response to the requesting user. FIG. 4 is a flow diagram illustrating an exemplary routine 400 for responding to a hashmap request from a computer user, as implemented by a hashmap service 122. Beginning at block 402, the hashmap service 122 receives a request in regard to one or more hashmaps that meet (to some predetermined degree of threshold) the criteria of the request.

At block 404, a determination is made with regard to the filters that are applicable to the hashmap request. Filters may include, by way of illustration and not limitation, a particular user (who posted the hashmap), date and/or time restrictions, subject matter restrictions (according to the content submitted and/or according to any tokens in the textual content), geo-location information indicating a particular point or region of the hashmap request, content type restrictions (e.g., a requesting user may wish to view hashmaps that include images), and the like.

At block 406, the hashmap service retrieves those hashmaps form the hashmap data store that satisfy the request according to the determined filters. For example, the hashmap service 122 may index all hashmaps from users according to a variety of keys, including by way of illustration and not limitation, subject matter, tokens, user identification, date, time, content type, geo-location, and the like. After having retrieved the hashmaps that satisfy the hashmap request, at block 408 the hashmap service 122 generates a hashmap response. According to various aspects of the disclosed subject matter, a hashmap response may simply be a record of all of the hashmaps that satisfy the hashmap request. Alternatively, or as part of the record of all of the hashmaps satisfying the hashmap request, a map or a map overlay that plots the various hashmaps (e.g., via actionable locators such as push-pins or some other actionable icon) for display as or overlay with a map that is displayed to the user. Thereafter, at block 410, the hashmap response is returned to the requesting user and the routine 400 terminates.

Regarding routines 200-400 described above, as well as other processes describe herein, while these routines/processes are expressed in regard to discrete steps, these steps should be viewed as being logical in nature and may or may not correspond to any specific actual and/or discrete steps of a given implementation. Also, the order in which these steps are presented in the various routines and processes, unless otherwise indicated, should not be construed as the only order in which the steps may be carried out. Moreover, in some instances, some of these steps may be omitted. Those skilled in the art will recognize that the logical presentation of steps is sufficiently instructive to carry out aspects of the claimed subject matter irrespective of any particular implementation and/or development language in which the logical instructions/steps are encoded.

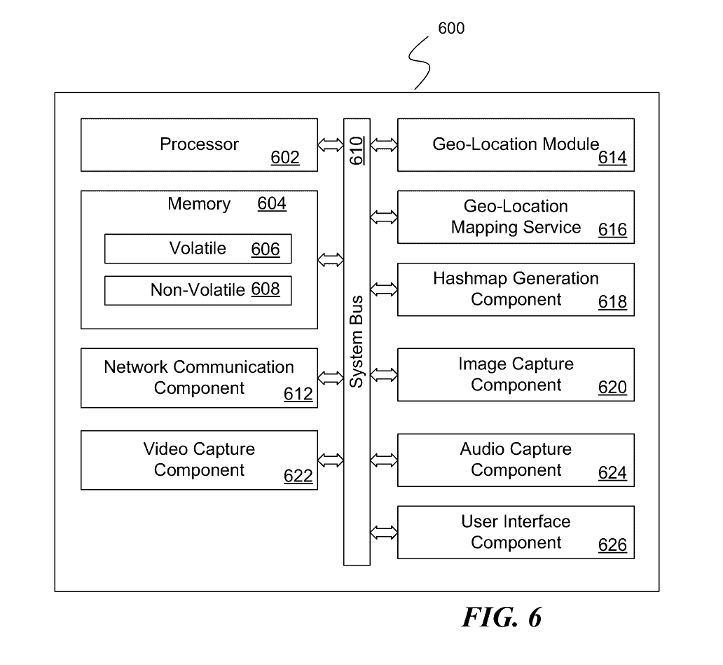

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 6 below. Additionally, in various embodiments all or some of the various routines may also be embodied in executable hardware modules including, but not limited to, system on chips (SoC's), codecs, specially designed processors and or logic circuits, and the like on a computer system.

These routines/processes are typically embodied within executable code modules comprising routines, functions, looping structures, selectors such as if-then and if-then-else statements, assignments, arithmetic computations, and the like. However, as suggested above, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may reproduce and/or deliver the computer-executable instructions and data to a computing device for execution by one or more processor via various transmission means and mediums including carrier waves and/or propagated signals, for purposes of this disclosure computer readable media expressly excludes carrier waves and/or propagated signals.

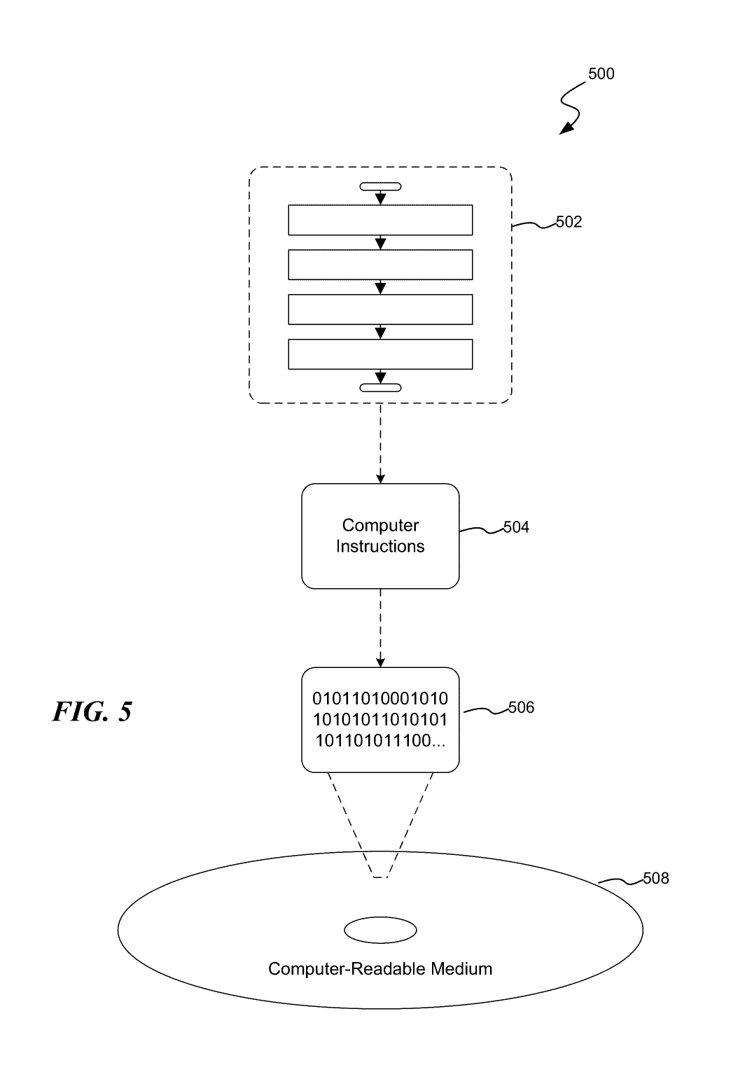

Turning to FIG. 5, this figure illustrates and exemplary computer-readable media that may be manufactured in accordance with the above description. More particularly, the implementation 500 comprises a computer-readable medium 508 (e.g., a CD-R, DVD-R or a platter of a hard disk drive), on which is encoded computer-readable data 506. This computer-readable data 506 in turn comprises a set of computer instructions 504 configured to operate according to one or more of the principles set forth herein. In one such embodiment 502, the processor-executable instructions 504 may be configured to perform a method, such as at least some of the exemplary method 200 of FIG. 2, for example. In another such embodiment, the processor-executable instructions 504 may be configured to implement a system, such as at least some of the exemplary system 600 of FIG. 6, as described below. Many such computer-readable media may be devised by those of ordinary skill in the art that are configured to operate in accordance with the techniques presented herein.

In regard to FIG. 6, as indicated above FIG. 6 is a block diagram illustrating an exemplary user computing device suitable for creating a hashmap. Indeed, the exemplary user computing device 600 includes one or more processors (or processing units), such as processor 602, and a memory 604. The processor 602 and memory 604, as well as other components, are interconnected by way of a system bus 610. The memory 604 typically (but not always) comprises both volatile memory 606 and non-volatile memory 608. Volatile memory 606 retains or stores information so long as the memory is supplied with power. In contrast, non-volatile memory 608 is capable of storing (or persisting) information even when a power supply is not available. Generally speaking, RAM and CPU cache memory are examples of volatile memory 606 whereas ROM, solid-state memory devices, memory storage devices, and/or memory cards are examples of non-volatile memory 608.

Further still, the illustrated user computing device 600 includes a network communication component 612 for interconnecting this computing device with other devices over a computer network, including a hosting computer 120 operating a hashmap service 122. The network communication component 612, sometimes referred to as a network interface card or NIC, communicates over a network (such as network 108) using one or more communication protocols via a physical/tangible (e.g., wired, optical, etc.) connection, a wireless connection, or both. As will be readily appreciated by those skilled in the art, a network communication component, such as network communication component 612, is typically comprised of hardware and/or firmware components (and may also include or comprise executable software components) that transmit and receive digital and/or analog signals over a transmission medium (i.e., the network.)

The processor 602 executes instructions retrieved from the memory 604 (and/or from computer-readable media, such as computer-readable media 500 of FIG. 5) in carrying out various functions, particularly in regard to responding to passively recording an ongoing audio or audio/visual stream and generating notes from the passive recordings, as discussed and described above. The processor 602 may be comprised of any of a number of available processors such as single-processor, multi-processor, single-core units, and multi-core units.

Further, the exemplary user computing device 600 also includes a geo-location module 614. According to at least one embodiment, the geo-location module 614 comprises executable hardware and/or software to determine a real-world geographic location of the user computing device in response to a request. As suggested above, the geo-location module 614 may be comprised of GPS hardware/software components configured to respond to a geo-location with geographic coordinates. Alternatively or additionally, the geo-location module 614 may further be comprised of an executable service that, in response to a geo-location request, can communicate with an external, third-party geo-location service over a network to obtain the geographic location of the user computing device 600.

As shown in FIG. 6, the exemplary user computing device 600 may also include a geo-location mapping service 616. As described above in regard to routine 300 of FIG. 3, the geo-location mapping service 616 typically is comprised of executable code which, in execution on the user computing device 600, can present/display a map to a computer user, and interact with the computer user such that the computer user is able to identify a location within the displayed map and translate the identified location in the displayed map to a geo-location in order for the computer user to generate a hashmap corresponding to that geo-location.

Also included in the user computing device 600 is a hashmap generation module 618. The hashmap generation module 618, in execution of the computing device 600, configures the computing device to obtain a geo-location from the geo-location module 614, or from the geo-location mapping service 616, and further obtain content from other components on the computing device such as (by way of illustration and not limitation) an image capture component 620 comprising hardware and/or software for capturing images, a video capture component 622 comprising hardware and/or software for capturing video content, an audio capture component 624 comprising hardware and/or software for capturing audio content, and a user interface component 626 comprising hardware and/or software for conducting I/O operations for interfacing with the user to obtain textual content, identify data files, hyperlinks, and the like for inclusion as content of a hashtag record. As discussed above, the hashmap generation module obtains the geo-location for a hashmap as well as the corresponding content, creates a hashmap record 250, and submits the hashmap record to the hashmap service 112 over the network 108 by way of the network communication component 612.

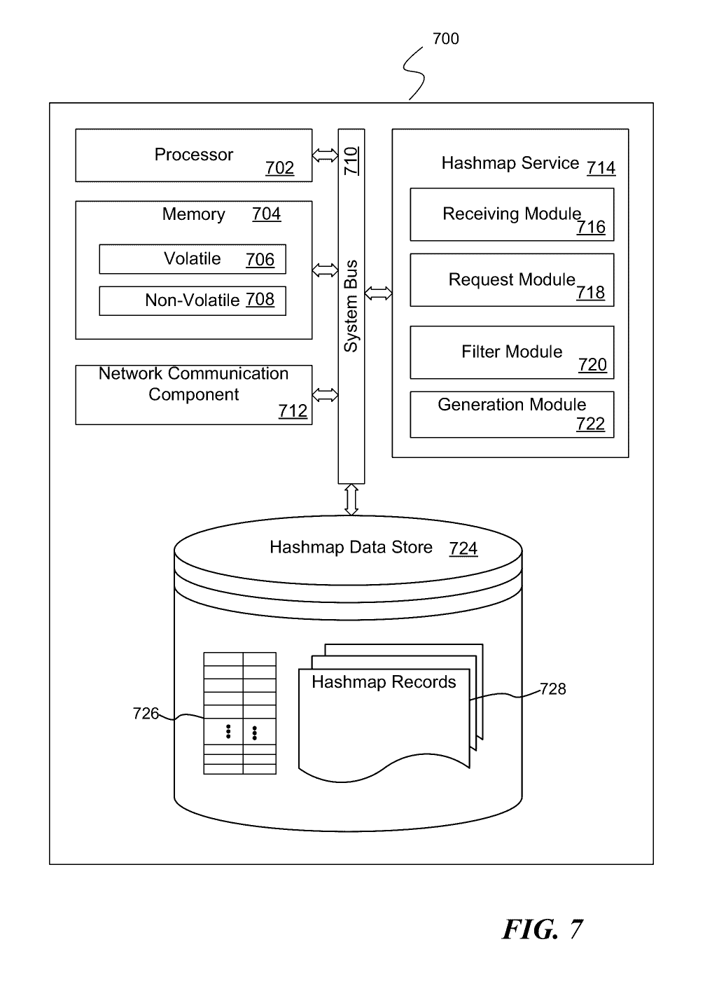

In contrast to the user computing device 600, FIG. 7 is a block diagram illustration an exemplary hosting computer 700 suitable for implementing a hosting service 122 for receiving hashmap records and responding to hashmap requests. As with the user computing device 600, the hosting computer 700 includes one or more processors (or processing units), such as processor 702, and a memory 704. The processor 702 and memory 704, as well as other components, are interconnected by way of a system bus 710. The memory 704 typically (but not always) comprises both volatile memory 706 and non-volatile memory 708. Volatile memory 706 retains or stores information so long as the memory is supplied with power. In contrast, non-volatile memory 708 is capable of storing (or persisting) information even when a power supply is not available. Generally speaking, RAM and CPU cache memory are examples of volatile memory 706 whereas ROM, solid-state memory devices, memory storage devices, and/or memory cards are examples of non-volatile memory 708.

The hosting computer 700 also includes a network communication component 712 for interconnecting this computing device with other devices over a computer network, including user computing device 600 as described above. The processor 702 executes instructions retrieved from the memory 704 (and/or from computer-readable media, such as computer-readable media 500 of FIG. 5) in carrying out various functions, particularly in regard to responding to passively recording an ongoing audio or audio/visual stream and generating notes from the passive recordings, as discussed and described above. The processor 702 may be comprised of any of a number of available processors such as single-processor, multi-processor, single-core units, and multi-core units.

The hosting computer 700 further includes a hashmap service component 714 comprising executable software and hardware which, in execution, provide a hashmap service 122 as set forth in regard to FIG. 1. The hashmap service component 714 comprises logical executable components including a receiving module 716, a request module 718, a filter module 720 and a generation module 722. The receiving module 716 receives hashmap records (such as hashmap record 250 of FIG. 2) from one or more computer users over a network 108 and adds the hashmap records to the hashmap data store 724 for access by one or more users. Typically, though not exclusively, the hashmap records 728 in the hashmap data store 724 are processed such that the various elements and components of each hashmap record are indexed in one or more indexes, such as index 726, in a manner for easy identification and retrieval.

The request module 718 is configured to receive one or more hashmap requests from computer users over the network 108. In response to each hashmap request (as discussed above in regard to routine 400 of FIG. 4), the request module 718 obtains hashmaps from the hashmap data store 724 that satisfy the hashmap request. These hashmaps are then filtered according to various filters as determined by the filter module 720, as discussed above in regard to step 404 of routine 400 of FIG. 4. After the hashmaps have been obtained and filtered, the generation module 722 generates a return record comprising the various hashmap records that are responsive to the hashmap request according to the applicable filters.

Regarding the various components of the exemplary user computing device 600 and the hosting computer 700, those skilled in the art will appreciate that these components may be implemented as executable software modules stored in the memory of the computing device, as hardware modules and/or components (including SoCs—system on a chip), or a combination of the two. Indeed, as indicated above, components such as the hashmap service component 714 and it sub-components including the receiving module 716, the request module 718, the filter module 720, and the generation module 722, may be implemented according to various executable embodiments including executable software modules that carry out one or more logical elements of the processes described in this document, or as a hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

Moreover, in certain embodiments each of the various components of the user computing device 600 and the hosting computer 700 may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network, such as network 108 of FIG. 1.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for generating a hashmap on a user computing device, the method comprising:
obtaining a geo-location for generating a hashmap, wherein the geo-location is obtained irrespective of any known entity at the geo-location;
obtaining content for the hashmap;
creating a hashmap record according to the geo-location and the content; and
submitting the hashmap record to a hashmap service over a computer network.

2. The computer-implemented method of claim 1, wherein obtaining the geo-location for generate the hashmap comprises obtaining the geo-location from a geo-location module disposed in the user computing device.

3. The computer-implemented method of claim 1, wherein obtaining the geo-location for generate the hashmap comprises obtaining the geo-location from a geo-location service provider external to the user computing device.

4. The computer-implemented method of claim 1, wherein obtaining the geo-location for generate the hashmap comprises:
displaying a map of an area to a computer user via the user computing device;
obtaining a user selection of a location on the displayed map; and
translating the selected location of the displayed map to a geo-location.

5. The computer-implemented method of claim 1, wherein obtaining content for the hashmap comprises obtaining textual content from the computer user of the user computing device as an item of content for the hashmap.

6. The computer-implemented method of claim 5, where the obtained textual content includes a token with a corresponding topic.

7. The computer-implemented method of claim 1, wherein obtaining content for the hashmap comprises obtaining an image as an item of content for the hashmap.

8. The computer-implemented method of claim 1, wherein obtaining the image as an item of content for the hashmap comprises obtaining the image from an image capture component of the user computing device.

9. The computer-implemented method of claim 1, wherein obtaining content for the hashmap comprises obtaining a video file as an item of content for the hashmap.

10. The computer-implemented method of claim 1, wherein obtaining content for the hashmap comprises obtaining an audio file as an item of content for the hashmap.

11. The computer-implemented method of claim 1, wherein obtaining content for the hashmap comprises obtaining any one or more of textual content, an image, a video file, or an audio file as one or more items of content for the hashmap.

12. The computer-implemented method of claim 1, wherein creating a hashmap record according to the geo-location and the content comprises including the geo-location and the content in the hashmap record, and further comprises including a user identifier corresponding to the computer user of the user computing device.

13. The computer-implemented method of claim 1, wherein creating a hashmap record according to the geo-location and the content comprises including the geo-location and the content in the hashmap record, and further comprises including access controls for restricting access by others to the hashmap.

14. The computer-implemented method of claim 1, wherein creating a hashmap record according to the geo-location and the content comprises including the geo-location and the content in the hashmap record, and further comprises including a date and time corresponding to the hashmap.

15. A computer-readable medium bearing computer-executable instructions which, when executed on a user computing device comprising at least a processor and a memory, carry out a method for generating a hashmap corresponding to a geo-location, the method comprising:
obtaining a geo-location for generating a hashmap, wherein the geo-location is obtained irrespective of any known entity at the geo-location;
obtaining content for the hashmap;
creating a hashmap record according to the geo-location and the content; and
submitting the hashmap record to a hashmap service over a computer network.

16. The computer-readable medium of claim 15, wherein obtaining the geo-location for generate the hashmap comprises at least one of:
obtaining the geo-location from a geo-location module disposed in the user computing device;
obtaining the geo-location over a network from a geo-location service provider external to the user computing device; and
obtaining the geo-location from a user selection of a location of a map, comprising the steps of
displaying the map of an area to the computer user via a user computing device;
obtaining a user selection of a location on the displayed map from the computer user; and
translating the selected location of the displayed map to a geo-location.

17. The computer-readable medium of claim 15, wherein the geo-location comprises a latitude/longitude coordinate pair.

18. The computer-readable medium of claim 15, wherein obtaining content for the hashmap comprises any one or more of:
obtaining textual content from the computer user of the user computing device as an item of content for the hashmap;
obtaining an image as an item of content for the hashmap;
obtaining a video file as an item of content for the hashmap; or obtaining an audio file as an item of content for the hashmap

19. A computer system for responding to a hashmap request from a computer user via a user computing device over a computer network, the computer system comprising a processor and a memory, wherein the processor executes instructions stored in the memory in implementing a hashmap service on the computer system, and wherein the computer system further comprises:
a hashmap service component; and
a hashmap data store, the hashmap data store storing a plurality of hashmaps for a plurality of computer users;
wherein, in operation, the hashmap service component:
receives a hashmap request and obtains hashmaps that satisfy the request via a request module;
filters the obtained hashmaps via a filter module according to one or more filters applicable to the requesting computer user; and
generates a return record via a generation module, the return record comprising one or more obtained, filtered hashmaps; and
returns the return record in response to the received hashmap request.

20. The computer system of claim 19, wherein the one or more filters applicable to the obtained hashmaps comprise any one or more of:
access restrictions regarding one or more users;
date and time restrictions;
subject matter restrictions determined according to the content submitted;
geo-location information indicating a particular point or region of the hashmap request; and
content type restrictions to hashmaps comprising a particular content type.
